(19) United States
(12) Patent Application Publication
(10) Pub. No.: US 2009/0111895 A1
(43) Pub. Date: Apr. 30, 2009

(54) ENHANCED DIALDEHYDE DISINFECTANT AND STERILIZATION FORMULATIONS

(75) Inventors: Peter C. Zhu, Cupertino, CA (US); Yvonne Tran, Murrieta, CA (US); Kaitao Lu, Irvine, CA (US); Xiaolan Chen, Irvine, CA (US); Harriet Chan-Myers, Lake Forest, CA (US)

Correspondence Address: K&L GATES LLP, 535 SMITHFIELD STREET, PITTSBURGH, PA, 15222, US

(73) Assignee: Ethicon, Inc., Somerville, NJ (US)

(21) Appl. No.: 12/180,953

(22) Filed: Jul. 28, 2008

Related U.S. Application Data
(63) Continuation of application No. 11/930,553, filed on Oct. 31, 2007, now abandoned.

(51) Int. Cl. A01N 35/04

(52) U.S. Cl. 514/699

(57) ABSTRACT

High-level disinfectant formulations and sporicidal formulations suitable for use as chemical disinfection and sterilization mediums comprising a dialdehyde, a carboxylate salt in amount of from about 3 weight percent to about 20 weight percent, and the balance water. The formulations are useful for disinfecting and sterilizing medical instruments and medical equipment.

### FIELD OF THE INVENTION

The invention relates to high-level disinfectant formulations and sterilization formulations useful for disinfecting or sterilizing articles. More particularly, the invention relates to enhanced formulations comprising a dialdehyde for high-level disinfection and sterilization of articles, for example, medical equipment.

### BACKGROUND OF THE INVENTION

It is essential that medical equipment that contacts semi-critical areas of the patient's body, such as mucous membranes or non-intact skin be clean and disinfected. Medical equipment that contacts critical areas of the body, such as the vascular system or body cavities, requires the more rigorous process of sterilization. And where prepackaged, single-use medical instruments are not cost effective, medical staff may reprocess the used medical instruments by disinfecting or sterilizing themselves. Typical disinfection and sterilization techniques for medical equipment involve heat. But where the equipment is heat-sensitive, chemical disinfection or sterilization is required.

Reprocessing of intermediate-risk medical equipment is generally accomplished by first cleaning and then high-level disinfection by boiling, by treating with moist heat at 70° C. to 100° C., or by treating with a chemical high-level disinfectant, such as ortho-phthalaldehyde formulations. High-level disinfectants typically do not kill high numbers of bacterial spores.

Reprocessing of high-risk medical equipment is generally accomplished by first cleaning and then sterilization by steam under pressure (autoclaving), dry heat (oven) or the use of chemical sterilization agents, such as ethylene oxide or hydrogen peroxide gas plasma. B. Garfinkle, et al., Sterilization in, II REMINGTON: THE SCIENCE AND PRACTICE OF PHARMACY 1463-1486 (A. R. Gennaro ed., 19^{th} ed., 1995). To be classified as a chemical sterilization medium, the formulation must destroy all viable microbial life including bacterial spores.

Dialdehydes, such as glutaraldehyde and ortho-phthalaldehyde, are known for their use in high-level disinfectant formulations. See, e.g., U.S. Pat. No. 4,851,449 (issued Jul. 25, 1989). For example, U.S. Pat. No. 5,223,166 (issued Jun. 29, 1993) discloses the use of disinfectant solutions comprising glutaraldehyde, glyoxal, malonaldehyde, and succinaldehyde. Glutaraldehyde has broad spectrum antimicrobial activity. Rutala, W. A. APIC guideline for selection and use of disinfectants, 24 AM. J. INFECT. CONTROL 313-342 (1996); Scott, E. M. et al., Glutaraldehyde in, Disinfection, Sterilization, and Preservation, 596-614 (Block S. S. ed., 4^{th} ed., 1991).

Ortho-phthalaldehyde also has broad-spectrum antimicrobial activity. Id.; U.S. Pat. No. 4,851,449. The FDA has cleared the ortho-phthalaldehyde disinfectant CIDEX® OPA, which is now marketed commercially by Advanced Sterilization Products. Id. CIDEX® OPA, comprises 0.55% ortho-phthalaldehyde, buffering agents, chelating agents and a corrosion inhibitor. See, CIDEX® OPA Solution, 510(k) Summary of Safety and Effectiveness, K991487 (Oct. 6, 1999); see also, product literature at www.cidex.com. Other aromatic aldehydes also have antimicrobial activity, for example, U.S. Pat. No. 6,071,972, discloses disinfectant formulations comprising isophthalaldehyde or terephthalaldehyde, in a buffering system.

Equipment turn-around time is very important when considering methods for high-level disinfection and sterilization. Thus, more active high-level disinfectant chemical formulations that act quickly are preferred. The FDA has cleared claims for glutaraldehyde high-level disinfection products that range from 20 minutes at 20° C. to 90 minutes at 25° C. Crawford, L. et al., Factors to consider when selecting an aldehyde based high-level disinfectant, MANAGING INFECTION CONTROL 78-80 (May 2003); Walsh, S. E., et al., Ortho-phthalaldehyde: a possible alternative to glutaraldehyde for high-level disinfection, 86 JOURNAL OF APPLIED MICROBIOLOGY 1039-1046 (1999). The ortho-phthalaldehyde high-level disinfectant CIDEX® OPA solution has an FDA approved HDL time of 12 minutes at 20° C. or 5 minutes at 25° C. in a validated Automated Endoscpoe Reprocessor. Id. However, ortho-phthalaldehyde is relatively ineffective against spores of B. subtilis, because of the resistance of the spore coat. Id.

In view of the foregoing, there is a need for high-level chemical disinfectants that have increased sporicidal activity and that act quickly for increased turn around of medical equipment.

### SUMMARY OF THE INVENTION

The invention provides activated, high-level disinfectant formulations and sporicidal formulations suitable for use as chemical sterilization mediums. The formulations of the invention are useful to disinfect or sterilize non-single use medical equipment. The formulations of the invention are particularly useful to sterilize heat-sensitive medical equipment that cannot be disinfected or sterilized using standard heating procedures.

The invention provides high-level disinfectant and sterilization formulations that are non-irritating to the eyes and respiratory system and that do not include noxious chemicals or require expensive equipment or complex procedures.

The formulations of the invention comprise a dialdehyde as the active agent and a carboxylate salt as an activator. In contrast to the prior art, which teaches that dialdehyde disinfectant formulations do not kill high levels of bacterial spores, the dialdehyde formulations of the invention are effective against bacterial spores.

While not wishing to be bound by any theory, it is believed that the specific concentrations of carboxylate salt disclosed herein increase the dialdehyde sporicidal activity by improving permeation of the dialdehyde through the spore coat, which in turn deactivates the spore. The formulations of the invention may further comprises additives and/or excipients including, but not limited to, corrosion inhibitors, buffering agents, chelating agents, colorants, surfactants, or fragrances or mixtures thereof.

Other advantages and novel features, and further scope of applicability of the present invention will be set forth in part in the detailed description to follow and in part will become apparent to those skilled in the art upon examination of the following, or may be learned by practice of the invention. The objects and advantages of the invention may be realized and attained by means of the instrumentalities and combinations particularly pointed out in the appended claims.

In one embodiment, the invention provides a formulation comprising:
(a) a dialdehyde, preferably wherein the dialdehyde gives a log₁₀ reduction/ml of 0.3 or greater according to the Bacillus subtilis sporicidal suspension test, which test is defined below;
(b) a carboxylate salt, preferably of the formula:

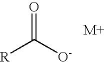

wherein:
   R is alkyl, aryl, alkenyl, alkynyl, unsubstituted or optionally substituted with one or two of alkyl, aryl, O-alkyl; O-alkenyl; O-alkynyl; O-aryl; CN; OH; oxo; halo; C(═O)OH; C(═O)O⁻M⁺, C(═O)halo; OC(═O)halo; CF₃; N₃; NO₂; NH₂; NH(alkyl); N(alkyl)₂; NH(aryl); N(aryl)₂; C(═O)NH₂; C(═O)NH(alkyl); C(═O)N(alkyl)₂; C(═O)NH(aryl); C(═O)N(aryl)₂; OC(═O)NH₂; NHOH; NOH(alkyl); NOH(aryl); OC(═O)NH(alkyl); OC(═O)N(alkyl)₂; OC(═O)NH(aryl); OC(═O)N(aryl)₂; CHO; C(═O)(alkyl); C(═O)(aryl); C(═O)O(alkyl); C(═O)O(aryl); OC(═O)(alkyl); OC(═O)(aryl); OC(═O)O(alkyl); OC(═O)O(aryl); S-alkyl; S-alkenyl; S-alkynyl; SC(═O)₂-aryl, SC(═O)₂-alkyl; SC(═O)₂-alkenyl; SC(═O)₂-alkynyl; or SC(═O)₂-aryl, and M is an alkali metal;
(c) water;

wherein a concentration of the dialdehyde is 0.1 weight percent to 10 weight percent, a concentration of the carboxylate salt is 1 weight percent to 20 weight percent, and preferably wherein a pH of the formulation the is from 5 to 8.5. The invention further provides methods for preparing and using such formulations.

### DETAILED DESCRIPTION

The formulations of the invention comprise: (1) a dialdehyde in an amount of from about 0.03 weight percent to about 10 weight percent, more preferably, of from about 0.05 weight percent to about 5 weight percent; (2) a carboxylate salt in amount of from about 3 weight percent to about 20 weight percent, more preferably, of from about 3.5 weight percent to about 15 weight percent, even more preferably, of from about 4 weight percent to about 10 weight percent; and (3) the balance water. Preferably the formulations of the invention are adjusted to a pH of from about 5 to about 9, more preferably, of from about 6 to about 8.5, still more preferably of from about 7 to about 8. As used herein, weight percent means the percentage weight of the component relative to the total formulation weight.

### 1. Definitions

“Cleaning”

As used herein, the term “cleaning” with respect to cleaning medical equipment means the process of removing foreign material from the equipment's surface, such as dirt, blood, or tissue, typically involving a detergent or enzymatic pre-soaking.

“High-Level Disinfectant”

As used herein, the term “high-level disinfectant” with respect to disinfecting medical equipment means a chemical composition or formulation that, when used as intended, destroys or reduces the level of microorganisms on a cleaned semi-critical use medical instrument to a level that is not harmful to health when the instrument is used as intended. A disinfectant may be ineffective or only partially effective against bacterial spores, depending on process conditions and concentrations.

“Sterilization”

As used herein, the term “sterilization” with respect to sterilizing medical equipment means a chemical agent or process that destroys all viable forms of microbial life including all bacterial spores.

“Intermediate-Risk or Semi-Critical Use Medical Instrument”

As used herein, the terms “intermediate-risk medical instrument” or “semi-critical use medical instrument” with respect to medical equipment means a medical instrument or medical equipment, that when used as intended, comes in contact with mucous membranes or non-intact skin, but which does not penetrate the skin or enter sterile areas of the body. Examples of semi-critical use instruments include, but are not limited to, respiratory equipment, flexible endoscopes, laryngoscopes, specula, endotracheal tubes, thermometers, and similar instruments. In general, semi-critical use medical instruments require cleaning followed by high-level disinfection prior to reuse.

“High-Risk or Critical Use Medical Instrument”

As used herein, the terms “high-risk medical instrument” or “critical use medical instrument” mean a medical instrument or medical equipment, that when used as intended, penetrates sterile tissues, such as body cavities or the vascular system. Examples of critical use medical instruments include, but are not limited to, surgical instruments, intra-uterine devices, vascular catheters, implants, etc. In general, critical use medical instruments require cleaning followed by sterilization prior to reuse.

“Bacillus subtilis Sporicidal Suspension Test”

The phrase “Bacillus subtilis sporicidal suspension test”, when used in the appended claims means a determination of the sporicidal activity of a dialdehyde calculated as a log reduction of Bacillus subtilis bacterial spores. The test is performed according to Example 1 by treatment of Bacillus subtilis bacterial spores with a formulation consisting of the dialdehyde to be tested in water. The log₁₀ reduction/mL is calculated from log N₀−log Nᵢ where N₀ represent the number of organisms (cfu/mL) at time zero; and Nᵢ represent the number of surviving organism (cfu/mL) at designated exposure time.

“Alkyl Group”

As used herein, the term “alkyl group” means a saturated, monovalent, unbranched or branched hydrocarbon chain. Examples of alkyl groups include, but are not limited to, (C₁-C₆) alkyl groups, such as methyl, ethyl, propyl, isopropyl, 2-methyl-1-propyl, 2-methyl-2-propyl, 2-methyl-1-butyl, 3-methyl-1-butyl, 2-methyl-3-butyl, 2,2-dimethyl-1-propyl, 2-methyl-1-pentyl, 3-methyl-1-pentyl, 4-methyl-1-pentyl, 2-methyl- 2-pentyl, 3-methyl-2-pentyl, 4-methyl-2-pentyl, 2,2-dimethyl-1-butyl, 3,3-dimethyl-1-butyl, 2-ethyl-1-butyl, butyl, isobutyl, t-butyl, pentyl, isopentyl, neopentyl, and hexyl, and longer alkyl groups, such as heptyl, and octyl. An alkyl group can be unsubstituted or optionally substituted with one or two suitable substituents.

“Aryl Group”

As used herein, the term “aryl group” means a monocyclic or polycyclic-aromatic radical comprising carbon and hydrogen atoms. Examples of suitable aryl groups include, but are not limited to, phenyl, tolyl, anthacenyl, fluorenyl, indenyl, azulenyl, naphthyl, and biphenyl as well as benzo-fused carbocyclic moieties such as 5,6,7,8-tetrahydronaphthyl. An aryl group can be unsubstituted or optionally substituted with one or two suitable substituents as defined below. An aryl group optionally may be fused to a cycloalkyl group, fused to another aryl group, fused to a heteroaryl group, or fused to a heterocycloalkyl group. Preferably, an aryl group is a monocyclic ring, wherein the ring comprises 6 carbon atoms, referred to herein as “(C6) aryl”.

“Alkenyl Group”

As used herein, the term “alkenyl group” means a monovalent, unbranched or branched hydrocarbon chain having one or more double bonds therein. The double bond of an alkenyl group can be unconjugated or conjugated to another unsaturated group. Suitable alkenyl groups include, but are not limited to (C₂-C₆) alkenyl groups, such as vinyl, allyl, butenyl, pentenyl, hexenyl, butadienyl, pentadienyl, hexadienyl, 2-ethylhexenyl, 2-propyl-2-butenyl, 4-(2-methyl-3-butene)-pentenyl. An alkenyl group can be unsubstituted or optionally substituted with one or two suitable substituents.

“Alkynyl Group”

As used herein, the term “alkynyl group” means monovalent, unbranched or branched hydrocarbon chain having one or more triple bonds therein. The triple bond of an alkynyl group can be unconjugated or conjugated to another unsaturated group. Suitable alkynyl groups include, but are not limited to, (C₂-C₆) alkynyl groups, such as ethynyl, propynyl, butynyl, pentynyl, hexynyl, methylpropynyl, 4-methyl-1-butynyl, 4-propyl-2-pentynyl, and 4-butyl-2-hexynyl. An alkynyl group can be unsubstituted or optionally substituted with one or two suitable substituents.

“Suitable Substituent”

As used herein, the term “suitable substituent” means a group that does not nullify the synthetic, therapeutic or pharmaceutical utility of the compounds of the invention or the intermediates useful for preparing them. Examples of suitable substituents include, but are not limited to: alkyl; alkenyl; alkynyl; aryl; heteroaryl; heterocycloalkyl; cycloalkyl; O-alkyl; O-alkenyl; O-alkynyl; O-aryl; CN; OH; oxo; halo; C(═O)OH; C(═O)halo; OC(═O)halo; CF₃; N₃; NO₂; NH₂; NH(alkyl); N(alkyl)₂; NH(aryl); N(aryl)₂; C(═O)NH₂; C(═O)NH(alkyl); C(═O)N(alkyl)₂; C(═O)NH(aryl); C(═O)N(aryl)₂; OC(═O)NH₂; C(═O)NH(heteroaryl); C(═O)N(heteroaryl)₂; NHOH; NOH(alkyl); NOH(aryl); OC(═O)NH(alkyl); OC(═O)N(alkyl)₂; OC(═O)NH(aryl); OC(═O)N(aryl)₂; CHO; C(═O)(alkyl); C(═O)(aryl); C(═O) O(alkyl); C(═O)O(aryl); OC(═O)(alkyl); OC(═O)(aryl); OC(═O)O(alkyl); OC(═O)O(aryl); S-alkyl; S-alkenyl; S-alkynyl; SC(═O)₂-aryl, SC(═O)₂-alkyl; SC(═O)₂-alkenyl; SC(═O)₂-alkynyl; and SC(═O)₂-aryl. One of skill in art can readily choose a suitable substituent based on the synthesis, stability and pharmacological activity of the compound of the invention.

“Halogen” or “Halo”

As used herein, the term “halogen” or “halo” means fluorine, chlorine, bromine, or iodine.

### 2. Formulations of the Invention

The formulations of the invention comprise: (1) a dialdehyde in an amount of from about 0.03 weight percent to about 10 weight percent, more preferably, of from about 0.05 weight percent to about 5 weight percent; (2) a carboxylate salt in amount of from about 3 weight percent to about 20 weight percent, more preferably, of from about 3.5 weight percent to about 15 weight percent, even more preferably, of from about 4 weight percent to about 10 weight percent; and (3) the balance water. Preferably the formulations of the invention are adjusted to a pH of from about 5 to about 9, more preferably, of from about 6 to about 8.5, still more preferably of from about 7 to about 8. As used herein, weight percent means the percentage weight of the component relative to the total formulation weight.

Carboxylate salts preferred for use in the invention are represented by the formula I below

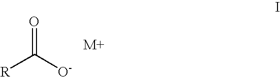

wherein R is alkyl, aryl, alkenyl, alkynyl, unsubstituted or optionally substituted with one or two of alkyl, aryl, O-alkyl; O-alkenyl; O-alkynyl; O-aryl; CN; OH; oxo; halo; C(═O)OH; C(═O)O⁻M⁺, C(═O)halo; OC(═O)halo; CF₃; N₃; NO₂; NH₂; NH(alkyl); N(alkyl)₂; NH(aryl); N(aryl)₂; C(═O)NH₂; C(═O)NH(alkyl); C(═O)N(alkyl)₂; C(═O)NH(aryl); C(═O)N(aryl)₂; OC(═O)NH₂; NHOH; NOH(alkyl); NOH(aryl); OC(═O)NH(alkyl); OC(═O)N(alkyl)₂; OC(═O)NH(aryl); OC(═O)N(aryl)₂; CHO; C(═O)(alkyl); C(═O)(aryl); C(═O)O(alkyl); C(═O)O(aryl); OC(═O)(alkyl); OC(═O)(aryl); OC(═O)O(alkyl); OC(═O)O(aryl); S-alkyl; S-alkenyl; S-alkynyl; SC(═O)₂-aryl, SC(═O)₂-alkyl; SC(═O)₂-alkenyl; SC(═O)₂-alkynyl; or SC(═O)₂-aryl.

Preferably R is alkyl or aryl, more preferably, R is methyl, ethyl, propyl, or phenyl. In another preferred embodiment, R is alkyl or aryl substituted with one or two halo groups, preferably, methyl, ethyl, propyl, or phenyl substituted with one or two halo groups.

M is an hydrogen, alkali metal, preferably, lithium, sodium, potassium, or rubidium, more preferably, M is sodium or potassium.

Examples of carboxylate salts useful in the invention include, but are not limited to, metal acetate, metal propionate, metal butyrate, metal pentanoate, metal 3-methylpentanoate, metal 3-methylbutanoate, metal 2,3-dimethylbutanoate, metal 3,3-dimethylbutanoate, metal 2-phenylpropanoate, metal benzoate, metal 2-phenylacetate, metal 2-chloroacetate, metal 2-chloropropanoate, metal 2-chloro-2-phenylacetate, metal 3,5-dichlorobenzoate, metal 2,3-dichlorobutanoate, metal 3-bromo-2-chlorobutanoate, metal 2-fluoroacetate, and metal 2,2,2-trifluoroacetate, where metal is an alkali metal, preferably, lithium, sodium, potassium, or rubidium, more preferably, sodium or potassium, even more preferably, sodium.

In one embodiment of the invention, the carboxylate salt is sodium acetate, potassium acetate, sodium chloroacetate, potassium chloroacetate, sodium propionate, potassium propionate, sodium benzoate, or potassium benzoate.

The weight percents of carboxylate salt present in formulations of the invention range from about 3 weight percent to about 20 weight percent, more preferably, of from about 3.5 weight percent to about 15 weight percent, even more preferably, of from about 4 weight percent to about 10 weight percent.

Suitable dialdehydes useful in the invention include any dialdehyde that has disinfectant properties. Preferred dialdehydes include those that when present in water at a concentration of 0.03 weight percent to about 10 weight percent and buffered to a pH of from about 5 to about 9. Perferably the dialdehyde of the invention has disinfectant properties such that when present in water at a concentration of 0.05 weight percent to about 5 weight percent and buffered to a pH of from about 6 to about 8.5.

Suitable dialdehydes include, but are not limited to dialdehydes of the formula I below:

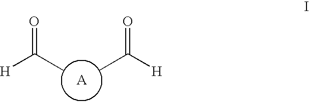

wherein:

the group A is alkyl, aryl, alkenyl, alkynyl, unsubstituted or optionally substituted with one or two of alkyl, aryl, oxo, or halo.

Suitable dialdehydes falling within formula I above, include, but are not limited to, glutaraldehyde, glyoxal, malonaldehyde, succinaldehyde, ortho-phthalaldehyde, isophthalaldehyde and terephthalaldehyde. Preferred dialdehydes for use in the invention include ortho-phthalaldehyde and glutaraldehyde.

Preferably, the dialdehyde is present in formulations of the invention in an amount of from about 0.03 weight percent to about 10 weight percent, more preferably, of from about 0.05 weight percent to about 5 weight percent. The preferred dialdehyde for use in the invention is ortho-phthalaldehyde, preferably in a concentration of from about 0.05 weight percent to about 0.8 weight percent, more preferably, of from about 0.1 weight percent to about 0.7 weight percent, still more preferably, of from about 0.3 weight percent to about 0.6 weight percent.

Optional additives suitable for use in the invention include, but are not limited to corrosion inhibitors, buffering agents, chelating agents, colorants, surfactants, and fragrances.

To protect instruments from corrosion it may be desirable to include a corrosion inhibitor in formulations of the invention. A corrosion inhibitor is a chemical compound that stops or slows down corrosion of metals and alloys. Mechanisms of corrosion inhibition include formation of a passivation layer, inhibiting either the oxidation or reduction part of the redox corrosion system, or scavenging dissolved oxygen. Suitable corrosion inhibitors for use in the invention include, but are not limited to, those disclosed in U.S. Pat. No. 6,585,933 entitled “Method and composition for inhibiting corrosion in aqueous systems,” the entire contents of which are hereby incorporated herein by reference. Examples of corrosion inhibitors include triazoles (benzotriazole, hydrobenzotriazole, carboxybenzotriazole), azoles, molybdates (sodium molybdate), vanadates, sodium gluconate, benzoates (sodium benzoate), tungstates, azimidobenzene, benzene amide, zinc oxide, hexamine, phenylenediamine, dimethylethanolamine, sodium nitrite, cinnamaldehyde, condensation products of aldehydes and amines (imines), alkanolamides, chromates, dichromates, borates, nitrites, phosphates, hydrazine, ascorbic acid, sodium silicate, sodium resinate and combination thereof. Preferred corrosion inhibitors for use in the invention include alkanolamide, sodium silicate, and triazoles. Preferably, the concentration of corrosion inhibitor is from about 0.0001 to about 5% by weight, more preferably from about 0.001 to about 2%, and most preferably from 0.002 to about 0.5%.

Suitable buffering agents for use in the formulations of the invention include, but are not limited to, Wayhib S (nitrilotriethyl acidphosphate), organic phosphates/inorganic phosphate system, Dipotassium Hydrogen phosphate/Potassium Dihydrogen phosphate system, Borax-Sodium/potassium hydroxide system, Boric Acid/Borax system; 2-Amino-2-methyl-1,3-propanediol (Ammediol) system, Barbital buffer system (sodium barbital/HCl), Tris(hydroxymethyl)aminomethane(Tris) system, Tris(hydroxymethyl)aminomethane-maleate(Tris-maleate) system, Citrate-Phosphate system, and Sodium citrate/citric acid system.

If a buffering agent is included, preferably, the buffering agent is present in formulations of the invention in an amount of from about 0.01 weight percent to about 2.5 weight percent, more preferably, of from about 0.1 weight percent to about 1.0 weight percent. The preferred buffering agent for use in the invention is Wayhib S (nitrilotriethyl acidphosphate), preferably in a concentration of from about 0.1 weight percent to about 1 weight percent, more preferably, of from about 0.2 weight percent to about 0.7 weight percent, still more preferably, of from about 0.3 weight percent to about 0.5 weight percent.

A suitable chelating agent may be included in formulations of the invention to assist dialdehyde stabilization during product storage or use. A chelating agent is a substance whose molecules can form several coordinate bonds to a single metal ion. That is, a chelating agent is a polydentate ligand. The most common and most widely used chelating agents are those that coordinate to metal ions through oxygen or nitrogen donor atoms, or through both. Chelating agents that coordinate through sulfur in the form of —SH (thiol or mercapto) groups are not as common in commercial applications, but they perform a significant role in complexing metal ions in biological systems. Suitable chelating agents for use in the formulations of the invention include, but not limited to, Versenol 120 (hydroxyethylethylenediamine tri-sodium acetate), Citric acid, Sodium Citrate, Potassium Citrate, Ethylenediamine, Ethylenediaminetetraacetic acid (EDTA), and Dimercaprol and/or the salt form of Ethylenediamine, Ethylenediaminetetraacetic acid (EDTA), and Dimercaprol.

If a chelating agent is included, preferably, the chelating agent is present in formulations of the invention in an amount of from about 0.00001 weight percent to about 10 weight percent. The preferred chelating agent for use in the invention is Versenol 120 (hydroxyethylethylenediamine tri-sodium acetate), preferably in a concentration of from about 0.00001 weight percent to about 10 weight percent, more preferably, of from about 0.00005 weight percent to about 1 weight percent, still more preferably, of from about 0.0001 weight percent to about 0.0003 weight percent.

If a dye or colorant is used in a formulation of the invention, it is chosen such that it does not effect the activity of the formulation. It is added merely as an indicator such that one can recognize the formulation is present. Any form of dyes can be used for this purpose. Suitable dyes or colorants for use in the formulations of the invention include, but not limited to, D&C Green Dye #5 (sodium 6,6′-(9,10-dioxo-9,10-dihydroanthracene-1,4-diyl)bis(azanediyl)bis(3-methylbenzenesulfonate)), preferably in a concentration of from about 0.00003 weight percent to about 0.0005 weight percent, more preferably, of from about 0.00007 weight percent to about 0.0004 weight percent, still more preferably, of from about 0.0001 weight percent to about 0.0003 weight percent.

### 3. Use of Formulations of the Invention to Disinfect or Sterilizer Non-Single Use Medical Equipment

The formulations of the invention are useful for high-level disinfection and sterilization of non-single use medical equipment, particularly, heat-sensitive medical equipment. Prior to disinfection or sterilization with formulations of the invention, the medical equipment must be cleaned by well known methods to remove all foreign and organic material from the medical instrument being processed. If the instruments have not been cleaned, disinfection and/or sterilization may not be effective because the microorganisms trapped in organic material may survive.

Cleaning can be done manually (using friction) or mechanically (ultrasonic cleaners, washer-sterilizers). Hinged items and items with lumens take special attention and inspection to ensure that debris has been removed. Sharp objects (such as scalpels, needles, blades, etc.) that are immersed during cleaning, are removed from the soaking solution using a strainer-type lifter, forceps or other tool, not by reaching into the solution by hand.

### 3.1 High-Level Disinfection Using Formulations of the Invention

The medical instrument must be cleaned before high-level disinfection. Open all hinged instruments and other items and disassemble those with sliding or multiple parts; the formulation of the invention must contact all surfaces in order for high-level disinfection with formulations of the invention to be ensured.

Place all subject items in the formulation of the invention so that they are completely submerged and soak for appropriate time depending on the chemical, concentration, and temperature. Proper procedures or guidelines should be followed to monitor the concentration and/or temperature of solution before use.

### 3.2 Sterilization Using Formulations of the Invention

Sterilization is a process which achieves the complete destruction or killing of all microorganisms, including bacterial spores.

Medical equipment can be sterilized by soaking in a formulation of the invention followed by rinsing in sterile water. The immersion time to achieve sterilization or sporicidal activity is specific the particular formulation of the invention.

Clean all items to be sterilized. Open all hinged instruments and other items. Disassemble those instruments with sliding or multiple parts because the solution must contact all surfaces for sterilization to be achieved. Place all items in the sterilization formulation of the invention so that they are completely submerged and soak for appropriate time depending on the chemical, concentration, and temperature. Proper procedures or guidelines should be followed to monitor the concentration and/or temperature of solution before use.

### 4. EXAMPLES

### 4.1 Example 1

Several ortho-phthalaldehyde based germicidal solutions were tested to determine their effectiveness in killing Bacillus subtilis (ATCC 19659) spores using the Bacillus subtilis sporicidal suspension test.

A lyophilized culture of Bacillus subtilis ATCC®19659 was reconstituted with commercial available nutrient broth per ATCC instruction, the culture was grown for 18-24 hours at 37° C. Aliquots (1-2 ml) of the growth were used to inoculate commercial available sporulation medium. The plates were incubated for 7 days at 37° C. before harvesting using 10 m sterile water. The resulting suspensions were centrifuged and washed three times using 10 ml sterile water. The resulting suspension was assayed for initial titer and stored at 4° C.

For preparation of the inoculating spore test suspension, a 1 ml aliquot of the spore harvest was serial diluted with sterile water to produce a spore suspension of approximately 1×10⁷ cfu ml.

Test solutions of ortho-phthalaldehyde/acetate were prepared by mixing acetate with CIDEX® OPA (which is a 0.55% solution of ortho-phthalaldehyde in water around pH 7.3, commercially available from Advanced Sterilization Products, a Johnson & Johnson Company) and diluted to levels indicated in Table 1. All components are commercially available.

The 1 ml aliquots of spore suspensions were exposed to 9 ml of ortho-phthalaldehyde solution at 20° C. (room temperature) for 5 hours as listed in Table 1 below. The pHs of the tested solutions were adjusted to 7.3-7.5.

The experiments were performed using the suspension test, which involved adding 1 ml of 10⁷ spores to sterile test tubes containing 9 ml of the challenge solution. The resulting test sample spore concentration was 10⁶ cfu /ml. The tubes containing the test suspension/spores were vortex briefly to allow for mixing of the solution/spores. At the end of each of the appropriate exposure time at 20° C., 1 ml aliquots of the solution/spores mixture were aseptically transferred to sterile filtration units containing 0.45μ membrane filters with 100 ml of neutralizer solution (1% w/v glycine solution). The solutions were filtered and the membrane filters were rinsed again with 100 ml of neutralizers solution. The membrane filters were then individually transferred onto the surface of commercially available sterile Tryptic Soy Agar plates. The plates were incubated at 37° C. for 48 hours. After incubation, the number of survivors were determined for each test sample/exposure time.

The log₁₀ reduction/mL is calculated from log N₀−log Nᵢ where N₀ represent the number of organism (cfu/mL) at time zero; and Nᵢ represent the number of surviving organism (cfu/mL) at designated exposure time.

The results are presented in terms of log₁₀ reduction/ml in Table 1.

TABLE 1
Ortho-Phthalaldehyde With Various Amounts of Acetate

| Composition | | Log₁₀ Reduction/ml |
|---|---|---|
| ortho-phthalaldehyde weight | | (20° C.) |
| percent | wt. % acetate | 5 hours exposure |
| 0 | 5.5 | 0.3 |
| 0.3 | 0 | 0.45 |
| 0.3 | 1 | 0.94 |
| 0.3 | 3 | 2.47 |
| 0.3 | 5 | 3.17 |
| 0.3 | 7 | 4.03 |
| 0.3 | 8 | 3.60 |
| 0.3 | 9 | 4.08 |
| 0.3 | 10 | 4.16 |
| 0.3 | 11 | 4.32 |
| 0.3 | 12 | 4.12 |

The results indicate that acetate alone does not have significant sporicidal activity nor does ortho-phthalaldehyde itself. The results also show that as the amount of acetate is increased, the sporicidal efficacy also increases. Based on the results in Table 1, increased sporicidal activity is observed when 3% or more acetate is included in ortho-phthalaldehyde solutions.

### 4.2 Example 2

In addition to acetate, several mixtures of ortho-phthalaldehyde with different carboxylates such as chloroacetate and propionate were also tested using the protocol described above in Example 1. The results are shown in Table 2 and Table 3 below.

TABLE 2
Ortho-Phthalaldehyde With Various Amounts of Chloroacetate

| | |
|---|---|
| | Log₁₀ Reduction/ml |
| Composition | (20° C.) |

| ortho-phthalaldehyde wt. % | chloroacetate wt. % | 5 hours exposure |
|---|---|---|
| 0.3 | 1 | 0.47 |
| 0.3 | 3 | 0.73 |
| 0.3 | 5 | 0.97 |
| 0.3 | 7 | <3.37 |

TABLE 3
Ortho-Phthalaldehyde With Various Amounts of Propionate

| | | Log₁₀ Reduction/ml |
|---|---|---|
| Composition | | (20° C.) |
| ortho-phthalaldehyde wt. % | propionate wt. % | 5 hours exposure |
| 0.3 | 1 | 1.05 |
| 0.3 | 3 | 2.40 |
| 0.3 | 5 | 3.15 |
| 0.3 | 7 | 3.60 |

The results in Tables 2 and 3 show that chloroacetate and propionate significantly enhance the sporicidal activity of ortho-phthalaldehyde.

### 4.3 Example 3

Benzoate was evaluated for its ability to enhance the sporicidal activity of ortho-phthalaldehyde using the protocol described above in Example 1. The pHs of all solutions were adjusted to neutral, 7.3-7.5. The results are presented in Table 4.

TABLE 4
Ortho-Phthalaldehyde With Various Amounts of Benzoate

| | | Log₁₀ Reduction/ml |
|---|---|---|
| Composition | | (20° C.) |
| ortho-phthalaldehyde wt. % | benzoate wt. % | 5 hours exposure |
| 0.3 | 1 | 0.59 |
| 0.3 | 3 | 1.61 |
| 0.3 | 5 | 1.33 |
| 0.3 | 7 | 1.40 |

The results in Table 4 indicated that benzoate enhances ortho-phthalaldehyde sporicidal efficacy when the benzoate concentration is above about 3%.

### 4.4 Example 4

Glutaraldehyde with potassium acetate was also evaluated to demonstrate that acetate can also enhance sporicidal efficacy of glutaraldehyde. Spore suspension tests with five germicide solutions containing 2.4% glutaraldehyde with various amounts of acetate ranging from 0 to 7% were conducted at 20° C. for 4 hours with Bacillus using the protocol described above in Example 1. The pHs of the solutions were adjusted to 8.2-8.9, which is the typical pH range for glutaraldehyde disinfecting solutions. The results are summarized in Table 5 below.

TABLE 5
2.4% Glutaraldehyde With Various Amount of Acetate

| | | Log₁₀ Reduction/ml |
|---|---|---|
| Composition | | (20° C.) |
| glutaraldehyde wt. % | acetate wt. % | 4 hours exposure |
| 2.4 | 0 | ~3.66 |
| 2.4 | 1 | 4.21 |
| 2.4 | 3 | 4.58 |
| 2.4 | 5 | 4.86 |
| 2.4 | 7 | 5.36 |

The results in Table 5 confirm that by adding acetate to glutaraldehyde, the sporicidal activity of glutaraldehyde is significantly enhanced.

### 4.5 Example 5

Additional ortho-phthalaldehyde-based formulations of the invention with varying concentrations of potassium acetate as well as a formulation comprising potassium acetate with no aldehyde were tested to determine their effectiveness in killing Bacillus subtilis spores using a time kill assay method. The experimental procedure is fundamentally the same as in Example 1 except with different exposure times.

Test solutions were prepared by mixing acetate with ortho-phthalaldehyde (if applicable) and the solutions were adjusted to pH 7.2.

The solutions were then challenged with 10⁶ per ml of Bacillus subtilis spores at 20° C. (room temperature). At each predetermined exposure time, samples from each of the test solutions were tested/assayed for survivors. The results are presented in terms of log₁₀ reduction/ml in Table 6.

TABLE 6
Time Kill Assay: Ortho-Phthalaldehyde (OPA) With Various Amounts of Acetate and Acetate Only.

| | | | | | | | | | |
|---|---|---|---|---|---|---|---|---|---|
| Exposure | | | | | | | | | |
| time | 0.3%* OPA | 0.3% OPA + | 0.3% OPA + | 0.3% OPA + | 0.3% OPA + | 0.3% OPA + | 0.3% OPA + | 0.3% OPA + | 6% acetate |
| (hours) | only | 2% acetate | 2.5% acetate | 3% acetate | 3.5% acetate | 4% acetate | 5% acetate | 6% acetate | only |

Log₁₀ reduction/ml

| | | | | | | | | | |
|---|---|---|---|---|---|---|---|---|---|
| 6 | 1.12 | 2.07 | 3.51 | 3.85 | 4.24 | 4.75 | 4.77 | 5.24 | 0.92 |
| 8 | 1.1 | 4.05 | 4.1 | 4.65 | 5.57 | 6.05 | 6.05 | 6.05 | 1.03 |
| 10 | 1.24 | 5.05 | 5.07 | 5.45 | 5.87 | 6.05 | 6.05 | 6.05 | 1.03 |
| 12 | 1.18 | 5.51 | 6.05 | 6.05 | 6.05 | 6.05 | 6.05 | 6.05 | 1.1 |
| 14 | 1.22 | 6.05 | 6.05 | 6.05 | 6.05 | 6.05 | 6.05 | 6.05 | 1.31 |
| 16 | 1.21 | 6.05 | 6.05 | 6.05 | 6.05 | | | | 1.21 |
| 18 | 1.75 | 6.05 | 6.05 | 6.05 | 6.05 | | | | 1.45 |
| 20 | 1.75 | | | | | | | | 1.28 |
| 22 | 1.75 | | | | | | | | 1.31 |
| 24 | 1.75 | | | | | | | | 1.1 |
| 28 | 3.05 | | | | | | | | 1.13 |
| 32 | 3.05 | | | | | | | | 1.13 |

*all “%” are weight percent relative to the total formulation weight.

The above results show by adding potassium acetate to ortho-phthalaldehyde, the sporicidal activity of ortho-phthalaldehyde is significantly enhanced; depending on the exposure time and acetate concentration, a total kill of 6 log₁₀ of Bacillus spores was demonstrated ranging from 14 hours at 20° C. with 0.3% ortho-phthalaldehyde+2% acetate to 8 hours at 20° C. with 0.3% ortho-phthalaldehyde+4% acetate.

The present invention is not to be limited in scope by the specific embodiments disclosed in the examples, which are intended as illustrations of a few aspects of the invention. Any embodiments that are functionally equivalent are within the scope of this invention. Indeed, various modifications of the invention in addition to those shown and described herein will become apparent to those skilled in the art and are intended to fall within the scope of the appended claims.

What is claimed is:

1. A formulation comprising:
(a) a dialdehyde;
(b) a carboxylate salt; and
(c) water
wherein a concentration of the dialdehyde is 0.03 weight percent to 10 weight percent, and a concentration of the carboxylate salt is 3 weight percent to 20 weight percent

2. The formulation of claim 1 wherein the dialdehyde is of the formula: 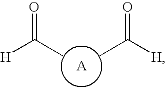
wherein:
the group A is alkyl, aryl, alkenyl, or alkynyl, wherein group A is unsubstituted or optionally substituted with one or two of alkyl, aryl, oxo, or halo.

3. The formulation of claim 2, wherein R is alkyl or phenyl, unsubstituted or optionally substituted with one or two halo.

4. The formulation of claim 1 wherein the carboxylate salt of the formula: 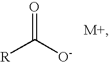
wherein:
R is alkyl, aryl, alkenyl, alkynyl, unsubstituted or optionally substituted with one or two of alkyl, aryl, O-alkyl; O-alkenyl; O-alkynyl; O-aryl; CN; OH; oxo; halo; C(═O)OH; C(═O)O⁻M⁺, C(═O)halo; OC(═O)halo; CF₃; N₃; NO₂; NH₂; NH(alkyl); N(alkyl)₂; NH(aryl); N(aryl)₂; C(═O)NH₂; C(═O)NH(alkyl); C(═O)N(alkyl)₂; C(═O)NH(aryl); C(═O)N(aryl)₂; OC(═O)NH₂; NHOH; NOH(alkyl); NOH(aryl); OC(═O)NH(alkyl); OC(═O)N(alkyl)₂; OC(═O)NH(aryl); OC(═O)N(aryl)₂; CHO; C(═O)(alkyl); C(═O)(aryl); C(═O)O(alkyl); C(═O)O(aryl); OC(═O)(alkyl); OC(═O)(aryl); OC(═O)O(alkyl); OC(═O)O(aryl); S-alkyl; S-alkenyl; S-alkynyl; SC(═O)₂-aryl, SC(═O)₂-alkyl; SC(═O)₂-alkenyl; SC(═O)₂-alkynyl; or SC(═O)₂-aryl, and M is an alkali metal.

5. The formulation of claim 4 wherein, M is sodium or potassium.

6. The formulation of claim 1 wherein a pH of the formulation is from 5 to 8.5.

7. The formulation of claim 1 wherein, the dialdehyde is glutaraldehyde, glyoxal, malonaldehyde, succinaldehyde, ortho-phthalaldehyde, isophthalaldehyde or terephthalaldehyde.

8. The formulation of claim 1 wherein, the concentration of the dialdehyde is 0.05 weight percent to 5 weight percent, the concentration of the carboxylate salt is 4 weight percent to 10 weight percent, and wherein the pH of the formulation the is from 6 to 8.

9. The formulation of claim 1 wherein, the carboxylate salt is sodium acetate, potassium acetate, sodium chloroacetate, potassium chloroacetate, sodium propionate, potassium propionate, sodium benzoate, or potassium benzoate.

10. The formulation of claim 1 wherein, the dialdehyde is ortho-phthalaldehyde.

11. The formulation of claim 1 wherein, the dialdehyde is ortho-phthalaldehyde, the carboxylate salt is sodium acetate or potassium acetate and wherein the pH is 7 to 7.5 and wherein the concentration of ortho-phthalaldehyde is 0.3 weight percent to 0.6 weight percent and the concentration of the carboxylate salt is 4 weight percent to 10 weight percent.

12. A method of disinfecting or sterilizing an article comprising contacting the article with a formulation comprising:
(a) a dialdehyde;
(b) a carboxylate salt; and
(c) water
wherein a concentration of the dialdehyde is 0.03 weight percent to 10 weight percent, and a concentration of the carboxylate salt is 3 weight percent to 20 weight percent

13. The method of claim 12 wherein the dialdehyde is of the formula: 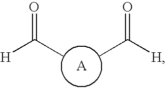
wherein:
the group A is alkyl, aryl, alkenyl, or alkynyl, wherein group A is unsubstituted or optionally substituted with one or two of alkyl, aryl, oxo, or halo.

14. The method of claim 13, wherein R is alkyl or phenyl, unsubstituted or optionally substituted with one or two halo.

15. The method of claim 12 wherein the carboxylate salt of the formula: 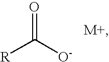
wherein:
R is alkyl, aryl, alkenyl, alkynyl, unsubstituted or optionally substituted with one or two of alkyl, aryl, O-alkyl; O-alkenyl; O-alkynyl; O-aryl; CN; OH; oxo; halo; C(═O)OH; C(═O)O⁻M⁺, C(═O)halo; OC(═O)halo; CF₃; N₃; NO₂; NH₂; NH(alkyl); N(alkyl)₂; NH(aryl); N(aryl)₂; C(═O)NH₂; C(═O)NH(alkyl); C(═O)N(alkyl)₂; C(═O)NH(aryl); C(═O)N(aryl)₂; OC(═O)NH₂; NHOH; NOH(alkyl); NOH(aryl); OC(═O)NH(alkyl); OC(═O)N(alkyl)₂; OC(═O)NH(aryl); OC(═O)N(aryl)₂; CHO; C(═O)(alkyl); C(═O)(aryl); C(═O)O(alkyl); C(═O)O(aryl); OC(═O)(alkyl); OC(═O)(aryl); OC(═O)O(alkyl); OC(═O)O(aryl); S-alkyl; S-alkenyl; S-alkynyl; SC(═O)₂-aryl, SC(═O)₂-alkyl; SC(═O)₂-alkenyl; SC(═O)₂-alkynyl; or SC(═O)₂-aryl, and M is an alkali metal.

16. The method of claim 16 wherein, M is sodium or potassium.

17. The method of claim 12 wherein, the article is a medical instrument.

18. The method of claim 17 wherein, the article is an endoscope.

19. The method of claim 12 wherein, the carboxylate salt is sodium acetate, potassium acetate, sodium chloroacetate, potassium chloroacetate, sodium propionate, potassium propionate, sodium benzoate, or potassium benzoate.

20. The method of claim 12 wherein, the dialdehyde is ortho-phthalaldehyde.

21. The method of claim 12 wherein, the concentration of the dialdehyde is 0.05 weight percent to 5 weight percent, the concentration of the carboxylate salt is 4 weight percent to 10 weight percent, and wherein the pH of the formulation the is from 6 to about 8.

22. The method of claim 12 wherein, the dialdehyde is ortho-phthalaldehyde, the carboxylate salt is sodium acetate or potassium acetate and wherein the pH is 7 to 7.5 and wherein the concentration of ortho-phthalaldehyde is 0.3 weight percent to 0.6 weight percent and the concentration of the carboxylate salt is 4 weight percent to 10 weight percent.
